(19) United States
(12) Patent Application Publication
(10) Pub. No.: US 2010/0034116 A1
(43) Pub. Date: Feb. 11, 2010

(54) NETWORK MANAGEMENT SYSTEMS AND METHOD FOR TESTING NETWORK DEVICES USING THE SAME

(75) Inventor: YU-CHUNG LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/247,203

(22) Filed: Oct. 7, 2008

(30) Foreign Application Priority Data
Aug. 8, 2008 (CN) 200810303627.9

(51) Int. Cl. H04L 12/26

(52) U.S. Cl. 370/253

(57) ABSTRACT

A network management system (100) includes a setting module (10), a scheduling module (20), a connection module (30), and a detection module (40). The setting module configures parameters of network devices (200) to be tested. The scheduling module schedules testing for at least one network device. The connection module connects to the network device a first testing time. The detection module detects whether the network device is idle. If the network device is idle, the detection module transmits at least one testing parameter to the network device.

### BACKGROUND OF THE DISCLOSURE

1. Field of the Disclosure

The disclosure relates to network management, and particularly to a network management system capable of simultaneously testing a plurality of network devices and a method for testing network devices using the system.

2. Discussion of the Related Art

With the development of telecommunications, many network devices with various functions have been adopted to provide network services. However, as the number of users and available functions increases, factors contributing to network failure increase correspondingly. Generally, a typical network management system (NMS) is configured for monitoring connected network devices in a real-time mode to enable efficient debugging.

The Simple Network Management Protocol (SNMP) is often utilized by network administrators to check the status of network devices. In use, each network device connected to the NMS executes a corresponding SNMP agent for managing the Management Information Base (MIB) stored in the network devices. The MIB stores NMS information and corresponding parameters thereof so that the SNMP agent can issue instructions from the NMS and generate warning messages in accordance with the MIB.

However, a typical NMS can only utilize SNMP instructions to detect the status of a single network device/module. For example, when an NMS is to determine if a public Switched Telephone Network (PSTN) module installed in a network device is functioning normally, the NMS can send only one SNMP instruction to the PSTN module at a time if the PSTN module is active, reducing efficiency considerably. When a plurality of network devices is to be detected by a typical NMS, time consumption increases commensurately. In addition, if a number of SNMP instructions are simultaneously sent to the plurality of network devices without first determining whether the devices are idle, the test may reduce network quality of service.

Therefore, there is room for improvement within the art.

### BRIEF DESCRIPTION OF THE DRAWINGS

Many aspects of the network management system can be better understood with reference to the following drawings. The components in the drawings are not necessarily to scale, the emphasis instead being placed upon clearly illustrating the principles of the present network management system. Moreover, in the drawings, like reference numerals designate corresponding parts throughout the several views.

FIG. 1 is an isometric view of a network management system according to an exemplary embodiment.

FIG. 2 is an isometric view of connections between the network management system of FIG. 1 and network devices tested thereby.

FIGS. 3A and 3B are flowcharts of a method for testing network devices using the network management system of FIG. 1 according to an exemplary embodiment.

### DETAILED DESCRIPTION OF THE EMBODIMENTS

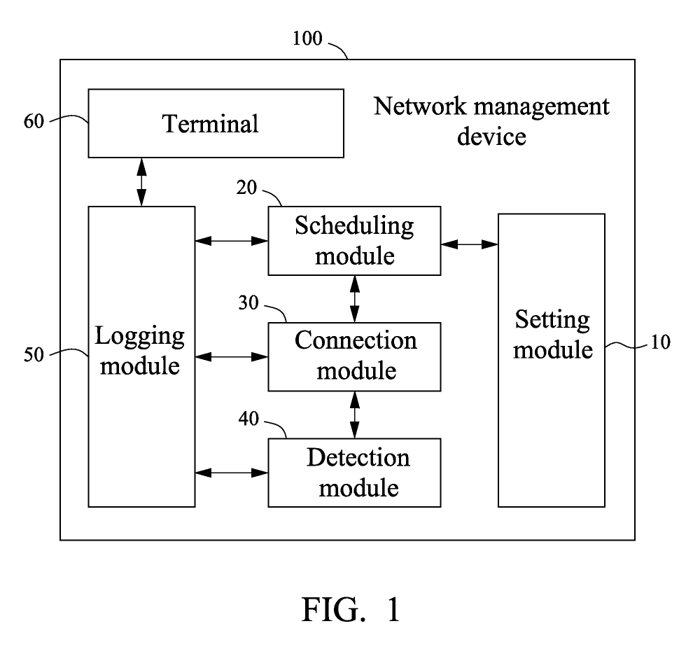

FIG. 1 shows a network management system 100 including a setting module 10, a scheduling module 20, a connection module 30, a detection module 40, a logging module 50, and a terminal 60.

The setting module 10 configures relevant parameters of network devices and/or network modules installed in the network devices. For network devices that do not include additional network modules, such as switches or hubs, the parameters relates only to the Internet Protocol (IP) addresses thereof. For network devices, including network modules that also include their own IP addresses, the parameters relates to the IP address of the network device, the IP addresses of the network modules, and the type of the network modules.

While, in an exemplary embodiment, the network modules can be PSTN modules, Integrated Service Digital Network (ISDN) modules, or Voice over Internet Protocol (VoIP) modules, this disclosure is not limited thereto.

Additionally, the setting module 10 configures a plurality of tests for network devices/modules. Each test includes a testing time indicating when the test initializes, and a waiting period indicating the amount of time after which the test will re-initialize if the test is not finished within the original testing time. In an exemplary embodiment, the testing time and the waiting period have default values. It is to be noted, however, that these values may be modified according to actual requirements. The values are transmitted to the scheduling module 20 after being set.

The scheduling module 20 is configured for scheduling and initializing the tests for at least one network device/module. In the exemplary embodiment, the scheduling module 20 adopts a multithread architecture for executing a plurality of tests at the same time. At the testing time, the scheduling module 20 first instructs the connection module 30 to establish a connection with the network device/module.

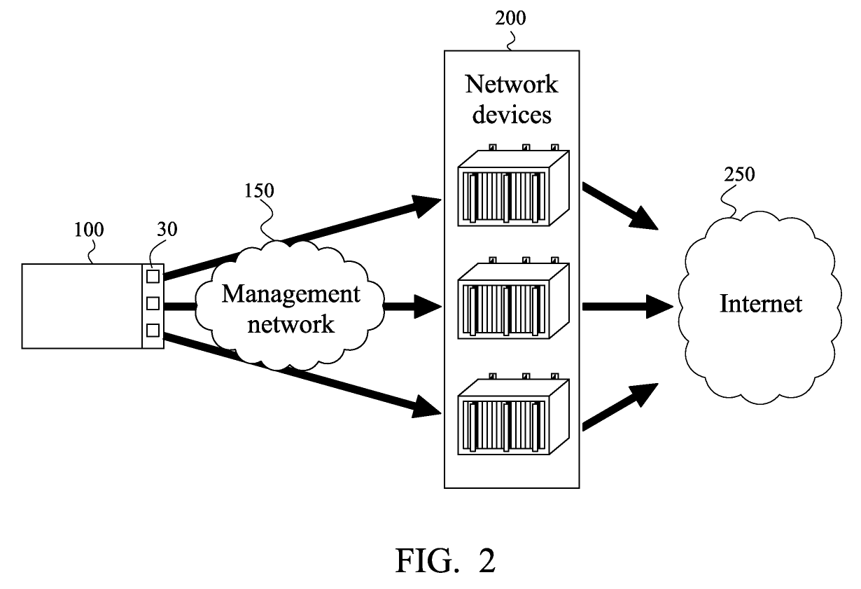

The connection module 30 establishes connection with the network device/module accordingly. As shown in FIG. 2, the connection module 30 of the network management system 100 connects to a plurality of network devices 200 via a management network 150, wherein the network devices 200 connect to the Internet 250. In the exemplary embodiment, the connection module 30, after successful connection, confirms the connection to the detection module 40. The confirmation can also be first sent to the scheduling module 20, which then relays the confirmation to the connection module 30.

Upon receiving the confirmation, the detection module 40 determines whether the network device/module is idle, by the management network 150 adopting SNMP as shown in FIG. 2.

If the network device/module is idle, the detection module 40 further conducts at least one test, to obtain a result, such as response time or traffic rate. In the exemplary embodiment, the setting module 10 is also configured for selecting the testing parameters for each test.

If the network device/module is busy, the detection module 40 stops the test immediately and notifies the scheduling module 20 that the test is to be delayed.

Upon receiving the notification, the scheduling module 20, upon expiration of the waiting period, re-initializes testing.

The logging module 50 is configured for recording the history of each test, such as results and whether testing is delayed. In the exemplary embodiment, logs for all tests are displayed for review on the terminal 60.

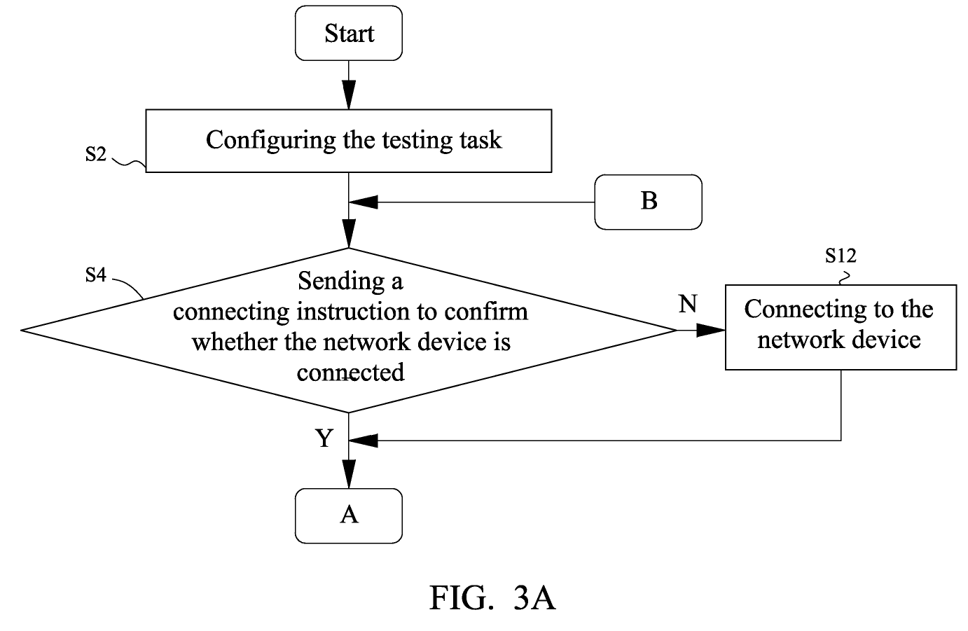

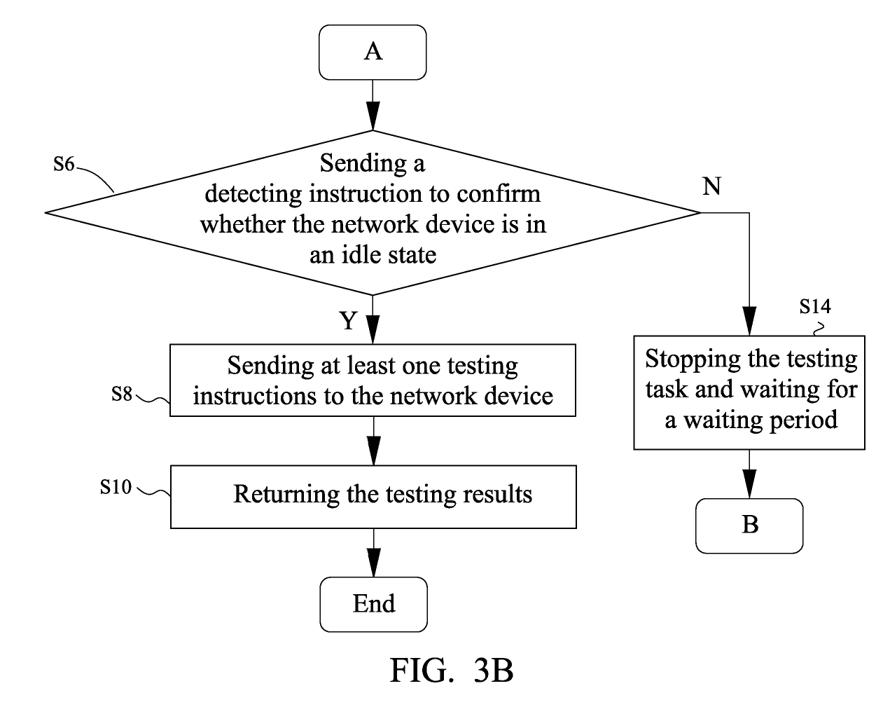

FIG. 3 illustrates a method for testing network devices using the network management system 100, according to an exemplary embodiment. In step S2, the network management device 100 configures testing information, which can include IP address and type of the network device/module, and the testing time and waiting period for the tests. In step S4, the network management system 100 confirms whether the network device/module is connected. If so, step S6 is executed. If not, step S12 is performed, in which the network management system 100 connects to the network device/module, after which step S6 is executed.

In step S6, the network management system 100 determines whether the network device/module is idle. If so, steps S8 and S10 are performed in turn.

In step S8, the network management system 100 issues at least one testing parameter to the network device/module. In step S10, the network management system 100 returns the testing results.

In step S6, if the network device is busy, step S14 is performed, in which network management system 100 stops the test and step S8 is repeated.

The network management system 100 sets up the first and second testing times and executes detection before the test, preventing the tests from being executed at busy times. In this way, quality of service is not reduced, and the work for network administrators is eased.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A network management system, comprising:
a setting module configuring parameters of network devices to be tested;
a scheduling module scheduling testing of at least one network device;
a connection module connecting to the network device at a first testing time;
a detection module determining whether the network device is idle; and
issuing at least one testing parameter to the network device if the network device is idle.

2. The network management system as claimed in claim 1, wherein the detection module utilizes simple network management protocol instructions for detecting states of the network devices.

3. The network management system as claimed in claim 2, wherein the detection module stops testing when the network device is busy, and further instructs the scheduling module to re-initialize testing after a preset waiting time.

4. The network management system as claimed in claim 1, wherein the scheduling module uses multithread architecture for executing a plurality of tests at one time.

5. The network management system as claimed in claim 1, wherein the parameters include an IP address of the network device.

6. The network management system as claimed in claim 1, wherein the parameters include IP addresses and types of network modules installed in the network device.

7. The network management system as claimed in claim 1, wherein the testing parameters are selected by the setting module.

8. The network management system as claimed in claim 1, wherein the testing results include response time and traffic rate.

9. The network management system as claimed in claim 1, wherein the network management system further comprises a logging module for recording the testing results.

10. The network management system as claimed in claim 9, wherein the network management system further comprises a terminal for displaying the testing results.

11. A method for testing network devices, comprising:
configuring test parameters for the network devices;
determining whether the network devices are connected to the network;
determining whether the network devices to be tested are idle; and
if the network device is idle, testing the network devices based on at least one testing parameter.

12. The method as claimed in claim 11, wherein the determining steps are performed using simple network management protocol instructions.

13. The method as claimed in claim 12, wherein if the network device is determined to be busy, the method further comprises stopping the test and re-initializing the test after expiration of a preset waiting time.

14. The method as claimed in claim 11, wherein the tests are performed in a multithread architecture.

15. The method as claimed in claim 11, wherein the parameters include an IP address of the network device.

16. The method as claimed in claim 11, wherein the parameters include IP addresses and types of network modules installed in the network device.

17. The method as claimed in claim 11, wherein the testing results include response time and traffic rate.

18. The method as claimed in claim 11, further comprising a logging step recording the testing results.
